(19) United States
(12) Patent Application Publication
(10) Pub. No.: US 2015/0053670 A1
(43) Pub. Date: Feb. 26, 2015

(54) TEMPERATURE-CONTROL STATION WITH HEATING BY INDUCTION

(71) Applicant: Benteler Automobiltechnik GmbH, Paderborn (DE)

(72) Inventors: Stefan Horn, Bad Emstal (DE); Karoline Käsewieter, Paderborn (DE); Simon Werneke, Buren (DE)

(21) Appl. No.: 14/463,183

(22) Filed: Aug. 19, 2014

(30) Foreign Application Priority Data
Aug. 20, 2013 (DE) 10 2013 108 972.0

(51) Int. Cl. H05B 6/40; C21D 1/42; H05B 6/10

(52) U.S. Cl. CPC H05B 6/40; H05B 6/105; C21D 1/42
USPC 219/632

(57) ABSTRACT

A temperature-control station of a thermoforming assembly for hot forming and press hardening a metallic structure includes a heat source in the form of at least one flat inductor which is provided on a lower tool and/or upper tool. A temperature-control plate is placed upon the inductor for support of the structure. The temperature-control plate is configured to accommodate at least one cooling channel for passage of a gaseous coolant so that two zones of the structure are adjustable to temperatures that are different from one another.

### CROSS-REFERENCES TO RELATED APPLICATIONS

This application claims the priority of German Patent Application, Serial No. 10 2013 108 972.0, filed Aug. 20, 2013, pursuant to 35 U.S.C. 119(a)-(d), the disclosure of which is incorporated herein by reference in its entirety as if fully set forth herein.

### BACKGROUND OF THE INVENTION

The present invention relates to a temperature-control station, and more particularly to a temperature-control station that can be incorporated in a thermoforming assembly for hot forming and press hardening a metallic structure.

The following discussion of related art is provided to assist the reader in understanding the advantages of the invention, and is not to be construed as an admission that this related art is prior art to this invention.

A temperature-control station is typically used between individual production steps to maintain structures at a controlled temperature, i.e. to heat or cool them, or to bridge possible shut-down times of a forming tool, when undergoing maintenance or malfunctioning so as to avoid, for example, a stoppage or slowdown of a thermoforming assembly used to produce hot formed and press hardened structures.

It would be desirable and advantageous to provide an improved temperature-control station to obviate prior art shortcomings.

### SUMMARY OF THE INVENTION

According to one aspect of the present invention, a temperature-control station, constructed for example for installation in a thermoforming assembly for hot forming and press hardening a metallic structure, includes a member selected from the group consisting of a lower tool and an upper tool, a heat source in the form of at least one flat inductor provided on the member, and a temperature-control plate placed upon the inductor for support of the structure, wherein the temperature-control plate is configured to accommodate at least one cooling channel for passage of a gaseous coolant so that two zones of the structure are adjustable to temperatures that are different from one another.

In accordance with the present invention, a flat inductor is used in the temperature-control station together with a temperature-control plate which is held above the flat inductor with respect to the vertical direction. The structure being processed may involve a blank made of a metallic material that can be hot formed and hardened, or a blank that is easily malleable, or also a pre-formed blank. A blank may be made of different wall thicknesses, e.g. tailored rolled blanks or tailored welded blanks, and placed upon the temperature-control plate. The structure can be maintained at a controlled temperature as a result of a contact between the structure and the temperature-control plate and the resultant heat conduction. As a result, at least two distinct temperature zones can be adjusted in the temperature-control plate to maintain two regions in the structure that have different temperatures as a result of the contact between the structure and the temperature-control plate. The at least two temperature zones in the temperature-control plate can be established by the flat inductor and cooling channels.

The flat inductor thus heats the temperature-control plate which, in turn, heats the structure placed upon the temperature-control plate. The temperature-control plate is hereby able to heat the structure to a temperature which is higher than the temperature of the structure when it is placed upon the temperature-control plate. Of course, the temperature-control plate may also maintain the structure at the temperature at the time when the structure is placed upon the temperature-control plate. The heating process to maintain or heat the structure occurs in particular at certain regions, wherein at least one region of the temperature-control plate is at a temperature which differs from the remainder of the temperature-control plate as a result of coolant flowing through the temperature-control plate. In other words, this at least one region can be cooled to a lower temperature. The coolant involved here can be in particular a gaseous coolant, especially compressed air, which flows at a selectable, variable flow rate and/or pressure through the cooling channel. Thus, the temperature-control plate can have regions at temperatures that differ from one another so that the structure can also have regions of different temperatures as a result of heat conduction when contacting the temperature-control plate.

According to another advantageous feature of the present invention, the heat source may include two flat inductors arranged side-by-side on the lower tool and/or upper tool and forming a flat inductor field. Of course, the provision of three or more flat inductors in side-by-side arrangement is conceivable as well. As adjacent flat inductors form a flat inductor field, it is possible to individually apply current to the various flat inductors so that the flat inductors can be used to adjust different temperature zones in the temperature-control plate.

Within the scope of the invention, a lower tool or upper tool may be involved which is structured to have a mounting or frame on the upper side or on the lower side of the temperature-control station. As a result, if need be, only the temperature-control plates have to be replaced to suit the product at hand, but not the frames.

According to another advantageous feature of the present invention, the temperature-control plate may be formed of at least two parts in spaced-apart relation to define an expansion gap there between. Advantageously insulating material may be arranged in the expansion gap. Thus, the various temperature-control plate parts are heated by the flat inductor, with at least one temperature-control plate part having cooling channels through which coolant can be routed. The temperature-control plate part through which coolant flows is at a cooler temperature than the temperature-control plate part which is heated solely by the flat inductor, resulting again in zones of the structure of different temperatures. The expansion gap prevents in particular a heat transfer through heat conduction within the temperature-control plate since the expansion gap is filled with air, in particular with an insulating material, so as to avoid a heat transfer from the temperature-control plate part at higher temperature to the temperature-control plate part of lower temperature.

According to another advantageous feature of the present invention, the cooling channel can be arranged in close proximity to the gap. In this way, the temperature-control plate part which should be colder is not heated by the inductor and/or heat transfer from adjacent regions of the temperature-control plate part at higher temperature. Thus, the structure has a particularly sharply edged transfer zone so that the structure during further processing has a region of maximum strength and a distinct, sharply edged region of greater ductility.

According to another advantageous feature of the present invention, in the cooler region, i.e. in the cooler temperature-control plate part, one or more cooling channels can be dispersed. In the event of one cooling channel, it can be configured as a heating coil snaking underneath the temperature-control plate. From a manufacturing standpoint, it may be advantageous to provide the temperature-control plate part with cooling channels in the form of bores, recesses or grooves that extend in a straight line through the entire temperature-control plate part. In particular when cooling grooves are involved, it is advantageous to produce the temperature-control plate part of at least two parts so that the groove forms a channel, when a face plate is attached.

The straight course of a cooling channel or the provision of several cooling channels have the further benefit to allow variation of the cooling capacity of the coolant flowing through the cooling channel(s) from the expansion gap in a direction towards the cooler region. Advantageously, the cooling capacity of the coolant flowing through the cooling channel(s) is greater in immediate proximity of the expansion gap and decreases in the direction to the cooler region of the temperature-control plate. It is thus conceivable to provide the structure with a homogenous temperature distribution up to the marginal region so that any influence in the area of the expansion gap from heat radiation or increased heat transfer of the warmer temperature-control plate parts is compensated such that the structure receives, as described above, a homogenous temperature distribution with sharply edged transition zone.

The cooling capacity of the coolant can be individually adjusted by varying the pressure and/or the flow rate so that fluctuations in the production can be addressed or the desired structure temperature can be adjusted for different structures through appropriate selection of pressure or flow rate. The coolant may involve compressed air. Another example of a coolant includes a circulating air stream so that there is no need for compressors, as would be the case for compressed air. Rather, the use of a fan is sufficient to provide the air stream. When using compressed air, a pressure between 0.1 MPa and 1 MPa is advantageous because the structure can then easily be adjusted to temperatures between 200° C. and 950° C. in combination with the temperature-control plate. It is also conceivable to cause turbulences in the cooling channels or to configure the cooling channel with an inner profile so as to realize increased heat exchange between coolant and temperature-control plate which accommodates the cooling channel. In order to be able to also transmit this heat exchange to the structure, it is also conceivable to apply a heat conducting agent, for example a heat-conducting paste or the like, upon the temperature-control plate.

According to another advantageous feature of the present invention, the temperature-control plate can have a contour conforming to a contour of the structure. In a simple configuration, a planar metal sheet blank of constant wall thickness is placed upon the temperature-control plate which has a complementary smooth or planar surface. It is also conceivable to use a tailored welded blank or tailored rolled blank of varying wall thickness, i.e., the blank would not flatly rest upon the temperature-control plate. To compensate for this irregularity, the temperature-control plate may be provided with respective height changes to ensure a flat contact across the entire surface area, even when a tailored blank is used. When the structure involves a preform or a tailored blank of complex three-dimensional configuration, it is possible within the scope of the invention to configure the temperature-control plate with a complementary three-dimensional surface contour so that such a structure would also substantially rest across the entire surface area upon the temperature-control plate. In the event the structure has assumed a final shape or substantially final shape, the temperature-control plate has a complementary surface.

According to another advantageous feature of the present invention, the upper tool can be configured for movement in a vertical direction. The upper tool can be provided in confronting relationship to the structure with a surface which is provided with an insulating layer, in particular a flexible insulating layer. The provision of the insulating layer enables energy consumption, required to maintain the structure at a desired temperature, to be kept to a minimum, since waste heat with accompanying energy loss is substantially prevented across the structure surface. In addition, the provision of a flexible insulating layer ensures again a full coverage of the structure and optimal contact with the subjacent temperature-control plate so that an optimal conductive heat transfer is realized from the temperature-control plate onto the structure.

According to another advantageous feature of the present invention, a slide can be provided underneath the temperature-control plate and configured to move the structure upwards. The slide is configured in the form of a plunger substantially moving in a vertical direction so that the structure can be lifted, at least by a minimum, after conclusion of the temperature-control process and grasped by a manipulator or the like for further use. The slide may also be movable in a linear direction at an angle between 45° and 90° in relation to the surface of the temperature-control plate so that the angular movement relative to the surface of the temperature-control plate causes not only a lifting of the structure but also a transfer of the structure in a direction for further use. For example, it is possible to use a gripper which is attached on the side of the temperature-control plate for easy grabbing of the structure as the structure juts out laterally when moved in horizontal direction.

Furthermore, it is possible to form the temperature-control plate with openings or grooves via which the temperature-control plate itself can be lifted.

According to another advantageous feature of the present invention, the inductor can have a meandering or helical shape to define inductor loops, and concentrators can be arranged below the inductor loops. In this way, the inductor covers a wide area beneath the temperature-control plate. The respective ends of the inductor may be routed for example from one side to the center or also from two opposite sides. Advantageously, the concentrators arranged in relation to the vertical direction below the inductor loops may have a U-shaped configuration. The respective legs of the U may hereby laterally embrace the inductor strand in relation to the vertical direction. As a result of the U-shaped cross section, especially field lines that emanate from the inductor are focused upon the temperature-control plate or into the temperature-control plate.

According to another advantageous feature of the present invention, the concentrators can be configured as metal sheets of U-shaped configuration. The metal sheets can have different configuration as far as wall thickness and/or length of the legs of the U-shaped cross section are concerned and can be attached replaceably on the temperature-control station depending on the heating capacity to be introduced into the temperature-control plate.

According to another advantageous feature of the present invention, an insulating layer can be provided underneath the inductor. The insulating layer ensures a deflection of the heat, produced by the inductor and/or the temperature-control plate, in a direction towards the structure, rather than a conduction downwardly with respect to the vertical direction. This measure also contributes to an optimum energy consumption of the temperature-control station according to the invention.

According to another advantageous feature of the present invention, a cooling plate with cooling bores for passage of a coolant may be arranged beneath the insulating layer with respect to the vertical direction. The cooling plate may be made form a metal part, and the coolant may involve a cooling liquid or a gaseous coolant. The cooling plate beneath the insulating layer prevents any thermal impact on system components adjacent to or surrounding the temperature-control station.

According to another advantageous feature of the present invention, spacers sized to extend through the inductor may be provided to support the temperature-control plate at a distance to the inductor. As a result, in particular in combination with the concentrators, it is possible to configure an optimal energy input into the temperature-control plate so that energy consumption of the temperature-control station is kept to a minimum. The spacers may involve dowel pins, e.g. ceramic dowel pins, and can be sized to engage openings in bores in the cooling plate arranged beneath the insulating layer. Advantageously, the distance between the inductor and the temperature-control plate is adjustable via the spacers. Suitably, the spacers are configured for adjustment in a vertical direction, and setscrews may be used to adjust the spacers in the vertical direction and may be provided underneath the spacers so that a turning of the setscrews enables an adjustment of the distance between the temperature-control plate and the inductor.

According to another advantageous feature of the present invention, the inductor can be configured as a meandering inductor loop to define conductor paths arranged in spaced-apart parallel relationship and having ends, with adjacent ones of the ends being coupled to one another by arcuate connections, respectively. The arcuate connection or the entire inductor loop may be formed in one piece and of same material. The inductor may, however, also be made of several parts which are coupled to one another by a material joint, for example by a thermal joining process. The conductor path, especially the entire inductor loop, can have a rectangular cross section. Of course other cross sections, such as oval or round cross sections or combinations thereof may also be conceivable.

According to another advantageous feature of the present invention, in an arrangement of several flat inductors in side-by-side relationship, each flat inductor can be constructed of same material according to the afore-mentioned criteria, and the inductors may be connected to one another or activated separately via respective lines.

According to another advantageous feature of the present invention, the temperature-control plate has a wall thickness and the conductor paths have each a width, wherein a ratio of the wall thickness to the width can range between 10:1 and 1:5, preferably 4:1 and 1:3, in particular from 2:1 to 1:2, and is most preferably 1:1, especially when the conductor path has a rectangular cross section. This means for example that the wall thickness of the temperature-control plate has a factor 1 and the width of the conductor path has a factor that is up to 2.5 times higher. In this way, the temperature input into the temperature-control plate is even and the field lines are evenly dispersed, in particular of adjacent conductor paths so that the temperature-control plate undergoes a homogenous, inductive heating.

According to another advantageous feature of the present invention, the conductor paths are spaced from one another by a distance, wherein a ratio of the wall thickness of the temperature-control plate to the distance between the conductor paths ranges between 10:1 and 1:5, preferably 4:1 and 1:3, in particular from 2:1 to 1:2, and is most preferably 1:1. Also in this way, when the wall thickness of the temperature-control plate is valued as 1, the distance between the conductor paths is up to 2.5 higher. This also results in an even distribution of the generated field lines and thus in an especially homogenous, inductive heating of the temperature-control plate and hence of the structure placed thereon.

According to another advantageous feature of the present invention, the distance between the individual conductor paths of the inductor can vary. For example, in sections that should be heated to a lesser degree, the distance is wider as compared to sections in which the distance between the individual conductor paths of the inductor is smaller so that the structure is heated to a greater degree. Advantageously, a constant distance between the individual conductor paths is, however, desired.

According to another advantageous feature of the present invention, the wall thickness of the temperature-control plate may vary. In particular, when a two-part temperature-control plate is involved, the use of temperature-control plate parts of different wall thicknesses is possible for controlling a temperature of tailored blanks. In this way, any jumps in thickness of the tailored blank can be compensated and the various regions of the tailored blank can be heated or controlled at a temperature to meet the requirement for the structure involved.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a top and side perspective view of one embodiment of a temperature-control station according to the present invention;

FIG. 1b is a top and side perspective view of the temperature-control station of FIG. 1a, without temperature-control plate;

FIG. 1c is a top and side perspective view of the temperature-control station of FIG. 1b, without insulating plate;

FIG. 2 is a cross sectional view of a variation of the temperature-control station;

FIG. 3a is a cross sectional view of another embodiment of a temperature-control station according to the present invention;

FIG. 3b is a longitudinal section of a temperature-control plate of the temperature-control station of FIG. 3a;

FIG. 3c is a top view of an inductor of the temperature-control station of FIG. 3a;

FIG. 4 is a cross sectional view of still another embodiment of a temperature-control station according to the present invention for a tailored blank;

FIG. 5a is a cross sectional view of still another embodiment of a temperature-control station according to the present invention;

FIG. 5b is a cross sectional view of still another embodiment of a temperature-control station according to the present invention; and

FIG. 5c is a cross sectional view of still another embodiment of a temperature-control station according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

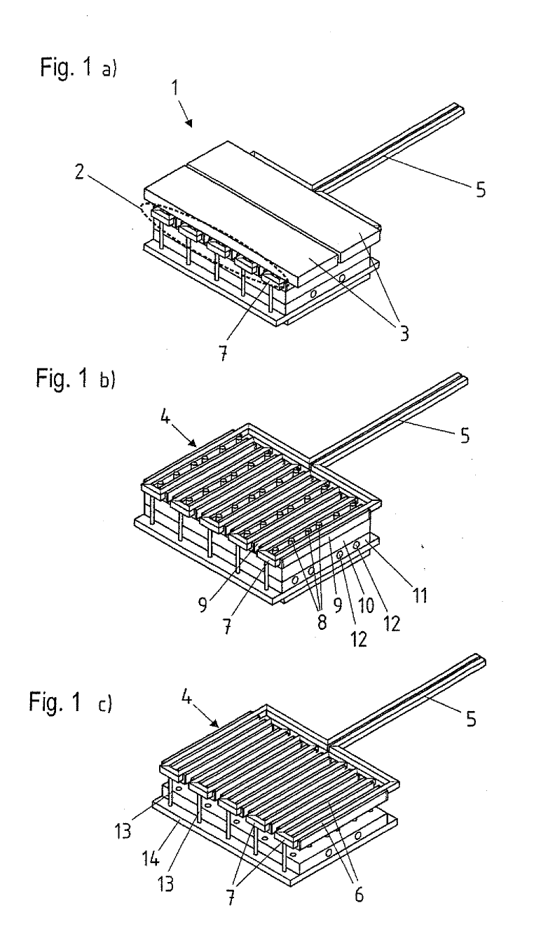

Turning now to the drawing, and in particular to FIG. 1a, there is shown a top and side perspective view of one embodiment of a temperature-control station according to the present invention, generally designated by reference numeral 1. The temperature-control station 1 includes a lower tool 2 and two temperature-control plates 3 which are positioned over the lower tool 2 and provided for support of a not shown structure or blank that is to be kept at a controlled temperature. The lower tool 2 includes a flat inductor 4 which is arranged underneath the temperature-control plates 3 and provided with a central feed and drain line 5. As shown in particular in FIGS. 1b and 1c, the flat inductor 4 has conductor paths 6 whose ends are coupled to one another by arcuate connections 7. The temperature-control plates 3 are sized shy of the arcuate connections 7 and thus do not jut out beyond the arcuate connections 7, as best seen in FIG. 1a. Rather the arcuate connections 7 extend with their border out beyond the temperature-control plates 3. As a result, the underside of the temperature-control plates 3 is covered solely by the conductor paths 6.

As shown in particular in FIG. 1b, dowel pins 8 are placed between adjacent conductor paths 6 to maintain a distance between the temperature-control plates 3 and the flat inductor 4. Although not shown in detail, the dowel pins 8 may be constructed for vertical adjustment. Arranged between the conductor paths 6 are concentrators 9 in the form of concentrator sheets which embrace the conductor paths 6 from below about their circumference so that the induction field is conducted in a direction towards the temperature-control plates 3. Arranged below the concentrators 9 is an insulating layer, configured advantageously in the form of an insulating plate 10, and a cooling plate 11 which is disposed underneath the insulating plate 10 and has cooling bores 12. The inductor 4 is supported on a baseboard 14 via bolts 13, especially threaded pins such a brass pins so as to maintain a constant distance to the subjacent cooling plate 11 and/or insulating layer 10.

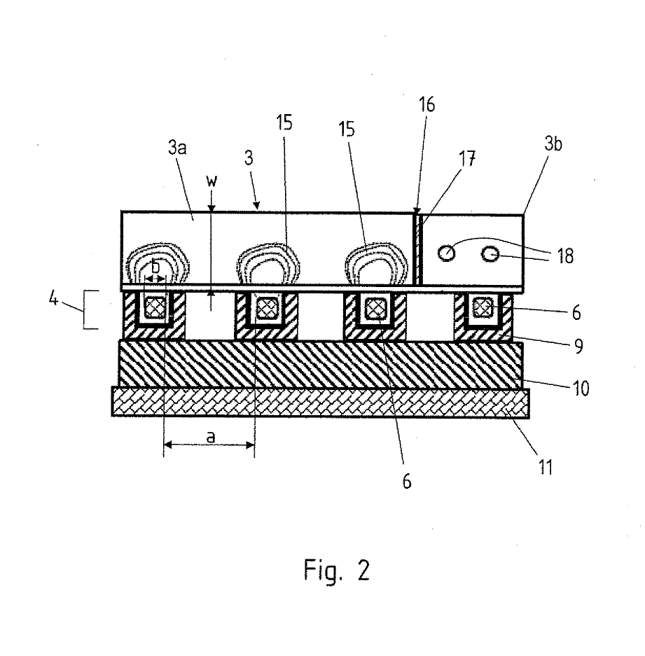

FIG. 2 shows a cross sectional view of a variation of the temperature-control station 1, depicting in particular the cooling plate 11, the insulating plate 10 and the U-shaped concentrators 9 disposed on the insulating plate 10 and embracing the conductor paths 6 of the flat inductor 4 so as to focus the field lines 15 in the direction of the temperature-control plates 3. In the non-limiting example of FIG. 2, the temperature-control station 1 has a temperature-control plate 3 which is comprised of two temperature-control plate parts 3a, 3b, with a gap 16 formed between the two temperature-control plate parts 3a, 3b. The gap 16 is filled with insulating material 17. The temperature-control plate part 3b on the right-hand side of the drawing plane is provided with cooling channels 18 in the form of cooling bores so that a lower temperature can be adjusted in the right-hand temperature-control plate part 3b as compared to area of the left-hand temperature-control plate part 3a. The field lines 15 on the right-hand side of the flat inductor 4 are not shown in FIG. 2 and cause only a negligible heating of the temperature-control plate part 3b because of the cooling capacity of a coolant flowing through the cooling channels 18. It is also conceivable to construct the flat inductor 4 as a controllable inductor so that the field lines can be switched off. The conductor paths 6 have each a width b which can be put in relation to a wall thickness w of the temperature-control plate 3. In accordance with the invention, the wall thickness w and the width b have a ratio which ranges between 10:1 and 1:5, preferably 4:1 and 1:3, in particular from 2:1 to 1:2, and is most preferably 1:1. Likewise a distance a between adjacent conductor paths 6 can be put in relation to the wall thickness w of the temperature-control plate 3. In accordance with the invention, a ratio of the wall thickness w to the distance a ranges between 10:1 and 1:5, preferably 4:1 and 1:3, in particular from 2:1 to 1:2, and is most preferably 1:1.

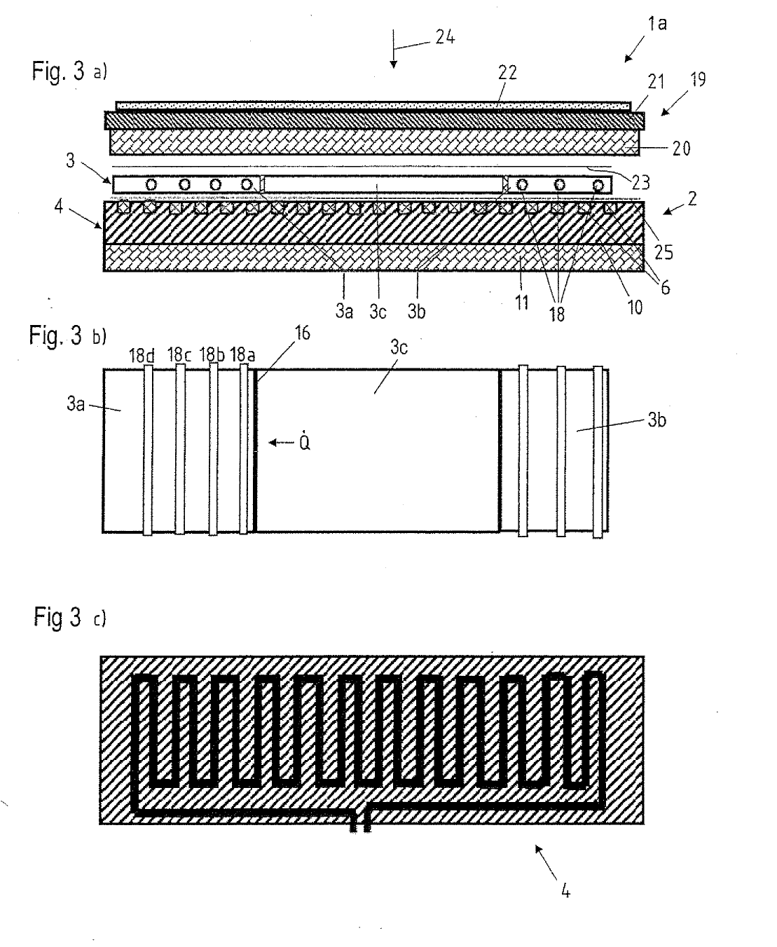

Referring now to FIG. 3a, there is shown a cross sectional view of another embodiment of a temperature-control station according to the present invention, generally designated by reference numeral 1a. Parts corresponding with those in FIG. 1a are denoted by identical reference numerals and not explained again. The description below will center on the differences between the embodiments. In this embodiment, the temperature-control station 1a has an upper tool 19 in addition to the lower tool 2. The upper tool 19 includes an insulating plate 20, a rigid baseboard 21 and a tolerance-compensating mat 22 on top of the baseboard 21. A blank or structure 23 placed between the upper tool 19 and the lower tool 2 is maintained conductively under a controlled temperature by lowering the upper tool 19 in direction of arrow 24 to press the structure 23 against the temperature-control plate 3 which is comprised here of three temperature-control plate parts 3a, 3b, 3c. In other words, the structure 23 is maintained at the desired temperature level or adjusted to the desired temperature level.

The central temperature-control plate part 3c is devoid of a cooling channel so that the temperature in this region can reach a highest temperature which may range between 200° C. and 900° C. The temperature-control plate parts 3a, 3b are provided with cooling channels 18 for circulation of a coolant so as to have a temperature that differs from the temperature of the central temperature-control plate part 3c.

An insulating layer 25 may, optionally, be arranged beneath the temperature-control plate 3 so that the temperature-control plate 3 is electrically decoupled from the subjacent flat inductor 4. In this embodiment, the flat inductor 4a is devoid of concentrators and has conductor paths 6 which are embedded in an insulating plate 10. Arranged underneath the insulating plate 10 is a support plate or a cooling plate 11.

FIG. 3b shows a longitudinal section of the temperature-control plate 3 of FIG. 3a and it can be seen that the temperature-control plate part 3a has four distinct cooling channels 18a, 18b, 18c, 18d. Coolant flows through the cooling channel 18a immediately adjacent to the gap 16 between the temperature-control plate parts 3a and 3c at highest volume flow and/or highest pressure in relation to the cooling channels 18b, 18c, 18d, which progressively are more distal to the gap 16 and in which the pressure or the volume flow decreases towards the outside so that a heat flow Q transferred from the insulating plate 10 is compensated by the greatest cooling capacity of the cooling channel 18a. A same situation is realized by the temperature-control plate part 3b having three cooling channels 18.

FIG. 3c is a top view of the flat inductor 4 of the temperature-control station 1a, and it can be seen that the flat inductor 4 substantially covers the entire base surface of the lower tool 2.

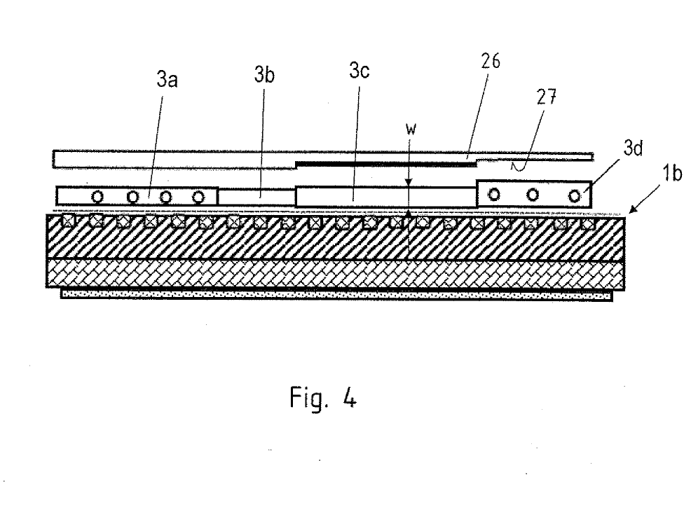

FIG. 4 is a cross sectional view of still another embodiment of a temperature-control station according to the present invention, generally designated by reference numeral 1b and configured for use with a tailored blank 26. In this embodiment, the temperature-control station 1b has a temperature-control plate 3 which is made of four parts to define temperature-control plate parts 3a, 3b, 3c, 3d of different wall thicknesses w to complement a contour of the tailored blank 26. As a result, the tailored blank 26 has an underside 27 which can substantially rest flatly upon the temperature-control plate parts 3a, 3b, 3c, 3d.

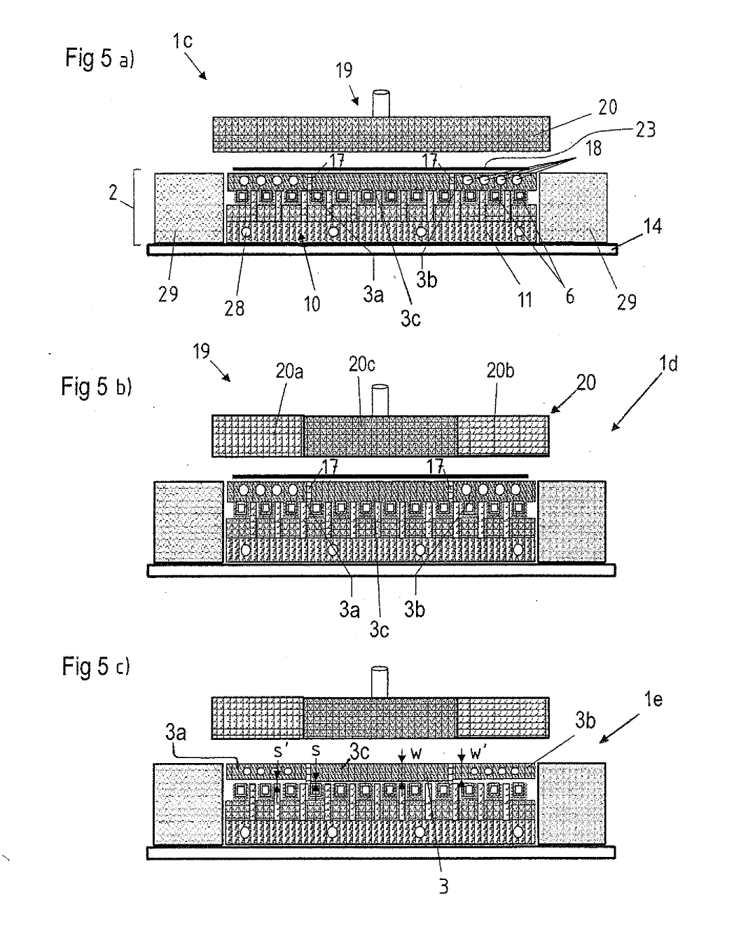

FIG. 5a is a cross sectional view of still another embodiment of a temperature-control station according to the present invention, generally designated by reference numeral 1c and including a lower tool 2 on which a blank or structure 23 can be placed. The lower tool 2 has a lower cooling plate 11 which is formed with cooling channels 28 for circulation of a coolant. The temperature-control plate 3 is comprised of three temperature-control plate parts 3a, 3b, 3c to define a left-hand temperature-control plate part 3a, a right-hand temperature-control plate part 3b, and a central temperature-control plate part 3c between the temperature-control plate parts 3a, 3b. While both the temperature-control plate parts 3a, 3b have formed therein cooling channels 18, the central temperature-control plate part 3c is devoid of any cooling channel so that the temperature-control plate parts 3a, 3b can be actively cooled in relation to the central temperature-control plate part 3c. The coolant may be air to flow in the cooling channels 18. An insulating material 17 is provided between the temperature-control plate parts 3a, 3b, 3c to thermally separate them from one another and to thereby realize particularly sharply edged, different strength zones.

The flat inductor 4 with its conductor paths 6 is arranged underneath the temperature-control plate 3 for heating the temperature-control plate parts 3a, 3b, 3c.

In addition, the temperature-control station 1c includes an upper tool 19 which has an insulating plate 20 and is provided for moving in a direction of the structure 23. As a result, heat loss can be kept to a minimum. An insulating plate 10 is arranged underneath the lower tool 2 so as to keep any heat loss also in this area to a minimum. Furthermore, lateral insulators 29 are provided to substantially eliminate heat or energy loss to the side. Overall, the temperature-control station 1c can be operated with little energy consumption.

FIG. 5b is a cross sectional view of still another embodiment of a temperature-control station according to the present invention, generally designated by reference numeral 1d. Parts corresponding with those in FIG. 5a are denoted by identical reference numerals and not explained again. The description below will center on the differences between the embodiments. In this embodiment, the upper tool 19 has an insulating plate 20 which is comprised of three tool parts 20a, 20b, 20c to define two outer tool parts 20a, 20b and a central tool part 20c which are configured to take into account the different heating needs of the temperature-control plate parts 3a, 3b, 3c. In other words, the tool parts 20a, 20b, 20c are configured to best suit the different heating of the temperature-control plate parts 3a, 3b, 3c, e.g. by using appropriate materials and/or varying wall thicknesses and/or providing a separation gap.

FIG. 5c is a cross sectional view of still another embodiment of a temperature-control station according to the present invention, generally designated by reference numeral 1e. Parts corresponding with those in FIG. 5b are denoted by identical reference numerals and not explained again. The description below will center on the differences between the embodiments. In this embodiment, the central temperature-control plate part 3c, which is not circulated by a coolant and thus not cooled, has a wall thickness w and the temperature-control plate parts 3a, 3b, which are cooled by circulating coolant, have a wall thickness W which is smaller than the wall thickness w. As a result a gap s′ is formed between the temperature-control plate parts 3a, 3b and the inductor 4, and a gap s is formed between the temperature-control plate part 3c and the inductor 4, with the gap s′ being greater than the gap s. As a result of the greater gap s, heat transfer into the temperature-control plate parts 3a, 3b is reduced so that relatively little active cooling capacity can be selected and the diameter and thus cooling capacity of cooling channels 18 can be sized smaller.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A temperature-control station, comprising:
a member selected from the group consisting of a lower tool and an upper tool;
a heat source in the form of at least one flat inductor provided on the member; and
a temperature-control plate placed upon the inductor for support of a structure, said temperature-control plate being configured to accommodate at least one cooling channel for passage of a gaseous coolant so that two zones of the structure are adjustable to temperatures that are different from one another.

2. The temperature-control station of claim 1, wherein the heat source includes two of said flat inductor arranged side-by-side on the member and forming a flat inductor field.

3. The temperature-control station of claim 1, wherein the temperature-control plate is formed of at least two parts spaced to define a gap there between.

4. The temperature-control station of claim 3, further comprising insulating material arranged in the gap.

5. The temperature-control station of claim 3, wherein the cooling channel is arranged in close proximity to the gap.

6. The temperature-control station of claim 1, wherein the temperature-control plate has a plurality of cooling channels spaced from one another such as to define a cooler zone.

7. The temperature-control station of claim 3, wherein the temperature-control plate has a plurality of cooling channels positioned with successively increasing distance to the gap and having a cooling capacity which decreases as the distance of the cooling channels to the gap increases.

8. The temperature-control station of claim 1, wherein the temperature-control plate has a contour conforming to a contour of the structure.

9. The temperature-control station of claim 1, wherein the upper tool is configured to apply an insulating layer onto the structure at a side which is proximal to the temperature-control plate.

10. The temperature-control station of claim 9, wherein the upper tool is configured for movement in a vertical direction.

11. The temperature-control station of claim 1, further comprising a slide provided underneath the temperature-control plate and configured to move the structure upwards.

12. The temperature-control station of claim 1, wherein the inductor has a meandering or helical shape to define inductor loops, and further comprising concentrators arranged below the inductor loops.

13. The temperature-control station of claim 12, wherein the concentrators have a U-shaped configuration.

14. The temperature-control station of claim 12, wherein the concentrators are configured as metal sheets of U-shaped configuration.

15. The temperature-control station of claim 1, further comprising an insulating layer provided underneath the inductor.

16. The temperature-control station of claim 15, wherein the insulating layer is a vermiculite plate.

17. The temperature-control station of claim 15, further comprising a cooling plate disposed underneath the insulating layer and having cooling bores for passage of a coolant.

18. The temperature-control station of claim 1, further comprising spacers sized to extend through the inductor and supporting the temperature-control plate at a distance to the inductor.

19. The temperature-control station of claim 18, wherein the spacers are configured for adjustment in a vertical direction.

20. The temperature-control station of claim 19, further comprising setscrews for adjusting the spacers in the vertical direction.

21. The temperature-control station of claim 18, wherein the spacers are configured as ceramic dowel pins sized to engage openings in the temperature-control plate.

22. The temperature-control station of claim 1, wherein the inductor is configured as a meandering inductor loop to define conductor paths arranged in spaced-apart parallel relationship and having ends, with adjacent ones of the ends being coupled to one another by arcuate connections, respectively.

23. The temperature-control station of claim 22, wherein the conductor paths have a rectangular cross section.

24. The temperature-control station of claim 22, wherein the temperature-control plate has a wall thickness and the conductor paths have each a width, wherein a ratio of the wall thickness to the width ranges between 10:1 and 1:5, preferably 4:1 and 1:3, in particular from 2:1 to 1:2, and is most preferably 1:1.

25. The temperature-control station of claim 22, wherein the temperature-control plate has a wall thickness and the conductor paths are spaced from one another by a distance, wherein a ratio of the wall thickness to the distance ranges between 10:1 and 1:5, preferably 4:1 and 1:3, in particular from 2:1 to 1:2, and is most preferably 1:1.

26. The temperature-control station of claim 1, constructed for installation in a thermoforming assembly for hot forming and press hardening the structure, said structure being made of metal.
